(19) United States
(12) Patent Application Publication
(10) Pub. No.: US 2013/0129599 A1
(43) Pub. Date: May 23, 2013

(54) SILICON CARBIDE AND METHOD FOR MANUFACTURING THE SAME

(71) Applicants: Byung Sook Kim, Seoul (KR); Jung Eun Han, Seoul (KR); Sang Myung Kim, Seoul (KR)

(72) Inventors: Byung Sook Kim, Seoul (KR); Jung Eun Han, Seoul (KR); Sang Myung Kim, Seoul (KR)

(73) Assignee: LG INNOTEK CO., LTD., Seoul (KR)

(21) Appl. No.: 13/813,026

(22) PCT Filed: Jul. 28, 2011
(86) PCT No.: PCT/KR2011/005580

§ 371 Date: Jan. 29, 2013

(30) Foreign Application Priority Data
Jul. 30, 2010 (KR) 10-2010-0074433

(51) Int. Cl. C01B 31/36

(52) U.S. Cl. CPC C01B 31/36
USPC 423/345

(57) ABSTRACT

Disclosed are a silicon carbide and a method for manufacturing the same. The method for manufacturing silicon carbide includes mixing a silicon source with a carbon source, and heating a mixture of the silicon and carbon sources to form the silicon carbide. At least one of the silicon source and the carbon source has an average grain size of about 10 nm to about 100 nm.

### TECHNICAL FIELD

The disclosure relates to silicon carbide and a method for manufacturing the same.

### BACKGROUND ART

Silicon carbide (SiC) is physically and chemically stabile and has superior thermal resistance and thermal conductivity, thereby representing superior high-temperature stability, high-temperature strength, and abrasion resistance. Therefore, the SiC has been extensively used when manufacturing high-temperature materials, high-temperature semiconductors, abrasion resistant materials and vehicle components.

Such SiC may be manufactured by mixing raw materials such as a silicon source and a carbon source and then heating the mixture of raw materials. An important issue in the method for manufacturing the SiC is to manufacture SiC having uniform and fine grain size.

### DISCLOSURE OF INVENTION

### Technical Problem

The embodiment provides silicon carbide having uniform and fine grain size and a method for manufacturing the same.

### Solution to Problem

According to the embodiment, there is provided a method for manufacturing silicon carbide including a raw material mixing step for mixing a fumed silicon source with a solid carbon source, and heating a mixture of the fumed silicon source and the carbon sources to form the silicon carbide. At least one of the fumed silicon source and the solid carbon source has an average grain size of about 10 nm to about 100 nm.

The fumed silicon source and the solid carbon source have average grain sizes of about 10 nm to about 100 nm. Each of the solid silicon source and the fumed carbon source has an average grain size of about 20 nm to about 50 nm.

The solid carbon source may include at least one selected from the group consisting of graphite, carbon black, carbon nanotube (CNT), and fullerene (C₆₀).

The fumed silicon source includes silica. The fumed silicon source may include at least one selected from the group consisting of silica powder, silica sol, silica gel, and quartz powder.

In the raw material mixing step, a mole ratio of carbon contained in the carbon source to silicon contained in the silicon source is in a range of about 1.5 to about 3. In this case, the mole ratio of carbon contained in the carbon source to silicon contained in the silicon source may be in a range of about 1.8 to about 2.7.

The silicon carbide is manufactured through the above method may have an average grain size of about 1 μm or less.

### Advantageous Effects of Invention

According to the method for manufacturing the silicon carbide of the embodiment, a heating temperature and heating time can be reduced by using a fumed Si source and a solid carbon source having an average grain size of about 10 nm to about 100 nm, preferably, about 20 nm to about 50 nm. In addition, grains of the manufactured silicon carbide can be uniform and fine.

The silicon carbide manufactured through the method according to the embodiment may have a fine average grain size of about 1 μm or less. Therefore, when sintering the silicon carbide, a sintering temperature and/or a sintering pressure can be reduced, so that the process cost can be reduced.

### BRIEF DESCRIPTION OF DRAWINGS

FIG. 1 is a flowchart showing the manufacturing process in a method for manufacturing silicon carbide according to the embodiment.

### MODE FOR THE INVENTION

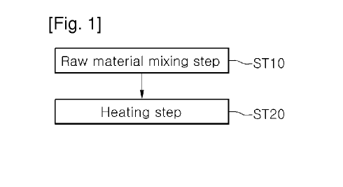

Hereinafter, the embodiment will be described in detail with reference to accompanying drawings. In other words, hereinafter, a method for manufacturing silicon carbide according to the embodiment will be described with reference to FIG. 1. FIG. 1 is a flowchart showing the manufacturing process in the method for manufacturing the silicon carbide according to the embodiment.

Referring to FIG. 1, the method for manufacturing the silicon carbide according to the embodiment includes a raw material mixing step ST10 and a heating step ST20. Hereinafter, each step will be described in more detail.

In the raw material mixing step ST10, after preparing an Si source and a C source, the Si source is mixed with the C source.

The Si source may include a fumed Si source. In detail, the fumed Si source may include various materials capable of providing Si. For example, the fumed Si source may include silica. The fumed Si source may include silica powder, silica sol, silica gel, and quartz powder.

The C source may include the solid C source. In detail, the solid C source may include various materials capable of providing C. For example, the solid C source may include graphite, carbon black, carbon nano tube (CNT), or fullerene (C₆₀).

The solid C source may be mixed with the fumed Si source through a wet mixing process employing a solvent, or a dry mixing process without a solvent. In this case, according to the wet mixing process, the solid C source and the fumed Si source can be condensed with each other, so that the productivity can be improved. In addition, according to the dry mixing process, the cost and the environmental pollution caused by the use of the solvent can be prevented, and a carbonization process can be omitted, so that the manufacturing process can be simplified.

After the Si source and the C source are mixed with each other by using a ball mill or an attrition mill, the mixed powder can be received. The mixed powder can be received by filtering the mixed powder through a sieve.

In this case, the mole ratio (hereinafter, the mole ratio of C to Si) of C contained in the solid C source to Si contained in the fumed Si source may be 1.5 to 5. If the mole ratio of C to Si exceeds 3, since a great amount of C exists, an amount of C remaining without participating in reaction is increased. Accordingly, the retrieval rate of the mixed powder may be reduced. In addition, if the mole ratio of C to Si is less than 1.5, since a great amount of Si exists, an amount of Si remaining without participating in reaction is increased. Accordingly, the retrieval rate of the mixed powder may be reduced. In other words, the mole ratio of C to Si is determined based on the retrieval rate of the mixed powder.

When taking into consideration that the fumed Si source is volatilized in a gas state at a high temperature in the heating step ST20, the mole ratio of C to Si may be 1.8 to 2.7.

In addition, according to the present embodiment, an average grain size of the fumed Si source and/or the solid C source may be in the range of about 10 nm to about 100 nm. If the average grain size exceeds 100 nm, the average grain size of the manufactured silicon carbide may be increased. In addition, it is difficult to provide the fumed Si source or the solid C source having the average grain size less than 10 nm. Preferably, the average grain size of the fumed Si source and/or the solid C source may be in the range of about 20 nm to about 50 nm.

Thereafter, the mixed powder (i.e., mixed raw materials) is heated in the heating step ST20, thereby forming the silicon carbide. In more detail, after the mixed powder has been weighed in a graphite crucible, the mixed powder is input into a high-temperature reactor, such as a graphite furnace, and heated. In this case, the heating temperature may be in the range of about 1300° C. to about 1900° C., preferably, in the range of about 1400° C. to about 1800° C. The heating time is about 30 minutes or more, for example, the heat time may be in the range of about one hour to 7 hours.

In detail, when the heating temperature is in the range of about 1500° C. to about 1800° C., the heating time may be in the range of about 30 minutes to seven hours. In other words, the heating time can be more reduced as compared with that of a method for synthesizing silicon carbide according to the related art. In other words, when the silicon carbide is synthesized under the same temperature, the heating time according to the embodiment may be reduced by two hours or more as compared with that of the heating time according to the related art.

The heating temperature can be more lowered as compared with that of the method for synthesizing the silicon carbide according to the related art. In other words, when the silicon carbide according to the embodiment is synthesized for the same time as that of the related art, the heating temperature can be more lowered by about 50° C. to about 100° C. per hour. Therefore, the manufacturing efficiency can be improved.

Then, the internal atmosphere of the high-temperature reactor may be a vacuum atmosphere or an inert gas atmosphere (for example, argon or hydrogen) atmosphere.

In the heating step ST20, the silicon carbide is formed according to reaction formula 3 obtained by reaction formulas 1 and 2.

SiO₂(s)+C(s)→SiO(g)+CO(g) [Reaction Formula 1]

SiO(g)+2C(s)→SiC(s)+CO(g) [Reaction Formula2]

SiO₂(s)+3C(s)→SiC(s)+2CO(g) [Reaction Formula 3]

According to the embodiment, since the fumed Si source, or the solid C source having an average grain size of about 10 nm to about 100 nm, preferably, about 20 nm to about 50 nm is used, a reaction according to reaction formula 1, which is a controlled reaction, can easily occur. Therefore, the heating time and/or the heating temperature can be lowered, so that the process cost can be reduced. In addition, the grains of the manufactured silicon carbide can be uniform and fine.

In this case, the average grain size of the fumed Si source or the solid C source, which is in the range of about 10 nm to about 100 nm, preferably, about 20 nm to about 50 nm, has advantages in forming the finer and more uniform grains of the silicon carbide. For example, when the average grain size of the fumed Si source and the solid C source is in the range of about 10 nm to about 100 nm, preferably, about 20 nm to about 50 nm, the silicon carbide having a fine average grain size of about 1 μm or less can be manufactured.

The silicon carbide manufactured through the above method is processed in a predetermined shape through a sintering process such as a press-sintering process, so that the silicon carbide may be used as a susceptor in deposition equipment or wafer carrier equipment. Since the silicon carbide has a fine average grain size of about 1 μm or less, the sintering temperature and/or the sintering pressure can be reduced in the sintering process. Therefore, the manufacturing cost in the sintering process for the silicon carbide can be reduced.

Hereinafter, the embodiment will be described in more detail through the method for manufacturing the silicon carbide according to first to second manufacturing examples, and a comparative example. The above manufacturing examples are used only for the illustrative purpose, but the embodiment is not limited thereto.

### Manufacturing Example 1

40 g of fumed silica was mixed with 18 g of a carbon black by using a ball mill. In this case, the average grain size of the fumed silica was about 40 nm, and the average grain size of the carbon black was about 20 nm.

After putting the mixed raw materials into the graphite furnace, the mixed raw materials were heated for two hours at the temperature of about 1800° C., thereby manufacturing the silicon carbide.

### Manufacturing Example 2

The silicon carbide was manufactured in the same manner as that of manufacturing example 1 except that the average grain size of the carbon black is about 40 nm.

### Manufacturing Example 3

The silicon carbide was manufactured in the same manner as that of manufacturing example 1 except that the average grain size of the fumed silica is about 10 nm, and the average grain size of the carbon black is about 40 nm.

### Comparative Example

40 g of silica powder was mixed with 18 g of graphite by using a ball mill. In this case, the average grain size of the fumed silica was about 2 μm, and the average grain size of the graphite was 3 μm.

After putting the mixed raw materials into a graphite furnace, the mixed raw materials were heated for five hours at the temperature of 1800° C., thereby manufacturing silicon carbide.

The measured average grain size of the silicon carbide manufactured according to manufacturing examples 1 to 3, and the comparative example is shown in table 1.

TABLE 1

| | Average grain size [μm] |
|---|---|
| Manufacturing Example 1 | 0.68 |
| Manufacturing Example 2 | 0.72 |
| Manufacturing Example 3 | 0.92 |
| Comparative Example | 3.22 |

Referring to table 1, the silicon carbide manufactured through Manufacturing Examples 1 to 3 has a fine average grain size of about 1 μm or less. In contrast, the silicon carbide manufactured through the comparative example has a great average grain size of about 3.22 μm. In other words, the silicon carbide manufactured through the method according to the embodiment can have a fine grain size.

In addition, the heating time of five hours is taken in the comparative example. In contrast, the heating time of two hours is taken in manufacturing examples 1 to 3. As described above, in manufacturing examples 1 to 3, even if the heating time is reduced, fine silicon carbide can be manufactured.

Any reference in this specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method for manufacturing silicon carbide, the method comprising:
mixing a silicon source with a carbon source; and
heating a mixture of the silicon and carbon sources to form the silicon carbide,
wherein at least one of the silicon source and the carbon source has an average grain size of about 10 nm to about 100 nm.

2. The method of claim 1, wherein the silicon source and the carbon source have average grain sizes of about 10 nm to about 100 nm.

3. The method of claim 2, wherein each of the silicon source and the carbon source has an average grain size of about 20 nm to about 50 nm.

4. The method of claim 1, wherein the carbon source includes a solid carbon source.

5. The method of claim 4, wherein the solid carbon source includes at least one selected from the group consisting of graphite, carbon black, carbon nanotube (CNT), and fullerene (C₆₀).

6. The method of claim 1, wherein the silicon source includes a fumed silicon source.

7. The method of claim 6, wherein the fumed silicon source includes silica.

8. The method of claim 7, wherein the fumed silicon source includes at least one selected from the group consisting of silica powder, silica sol, silica gel, and quartz powder.

9. The method of claim 1, wherein, in the mixing the silicon source with the carbon source, a mole ratio of carbon contained in the carbon source to silicon contained in the silicon source is in a range of about 1.5 to about 3.

10. The method of claim 1, wherein, in the mixing the silicon source with the carbon source, a mole ratio of carbon contained in the carbon source to silicon contained in the silicon source is in a range of about 1.8 to about 2.7.

11. The method of claim 1, wherein the heating the mixture of the silicon and carbon sources is performed for 30 minutes to two hours.

12. The method of claim 11, wherein the heating the mixture of the silicon and carbon sources is performed at a temperature of about 1500° C. to about 1800° C.

13. Silicon carbide manufactured through the method for manufacturing the silicon carbide according to claim 1.

14. The silicon carbide of claim 13, wherein the silicon carbide has an average grain size of about 1 μm or less.
